(19) United States
(12) Patent Application Publication
(10) Pub. No.: US 2008/0008568 A1
(43) Pub. Date: Jan. 10, 2008

(54) Automated Stocking And Retrieval System

(76) Inventors: Brad Harris, Dawsonville, GA (US); Charles Daugherty, Cuming, GA (US)

Correspondence Address: TROUTMAN SANDERS LLP, 600 PEACHTREE STREET , NE, ATLANTA, GA, 30308, US

(21) Appl. No.: 11/768,505

(22) Filed: Jun. 26, 2007

Related U.S. Application Data
(60) Provisional application No. 60/805,924, filed on Jun. 27, 2006.

(51) Int. Cl. B65G 1/00

(52) U.S. Cl. 414/281

(57) ABSTRACT

The invention provides a solution for automatically stocking, storing, dispensing, retrieving and sorting individual parts or products of a variety of types and sizes and weights for order fulfillment. The invention includes a series of vertical and horizontal carousels that converge to exchange products gently without dumping. Multiple products and/orders can be dispensed simultaneously and sorted for packing. Products can be stocked and retrieved simultaneously. The invention concentrates personnel to a stocking line and eliminates walk time to each location. Additionally, the invention eliminates the need for personnel to pick and sort orders.

### CROSS-REFERENCE TO RELATED APPLICATIONS

This application claims the benefit under 35 USC §119(e) to U.S. Provisional Patent Application Ser. No. 60/805,924 filed on 27 Jun. 2006, hereby incorporated by reference in its entirety.

### BACKGROUND OF THE INVENTION

1. Field of the Invention

The present invention relates generally to a stocking and retrieval system, and, more specifically, to an automated stocking and retrieval system capable of stocking, storing, dispensing, and sorting of homogenous and/or non-homogenous products for order filling applications.

2. Description of Related Art

Receiving, stocking, retrieving, and shipping items is common practice in the consumer products industry. Warehouses or distribution centers are generally used to store a supply of items or products for a predetermined period of time, i.e., until the items are sold, collected, and shipped. The manual process of stocking and retrieving products by hand can be very time consuming and expensive, especially for larger warehouses having a multitude of products. To reduce the time and costs associated with manually stocking, retrieving and sorting products, automated systems have been developed.

Conventional warehousing automation systems typically include opposing storage frames with storage bins arranged in a vertical and/or horizontal manner. A load carrier generally moves automatically along the aisles of the storage frames and often uses an elevator to transport objects to different shelving levels of the storage frames. To assist in retrieving and storing products, the elevator or load carrier may be equipped with an extractor or load handling mechanism for transferring a product from the carrier to the selected storage bin within the storage frame and, similarly, for picking a product from a selected storage bin to a carrier for delivery to a packing station. This system is typically used for bulk packaged products and is not designed for broken case picking.

To assist in transferring products to and from the load carriers, the storage frame can also include inbound and outbound conveyors. The inbound carriers can move stock to an associated pickup and discharge station for handling by the load carrier, while the outbound carriers can move particular items from the storage volumes to a packing station. The inbound and outbound conveyors are generally situated lateral to the storage frame and lead to pickup and packing stations located nearby. Such conveyors and shelving units require considerable floor space for installation.

To expedite the process of stocking and retrieving items from shelving, storage conveyors with multiple levels have been introduced and are widely used for the storing and handling of relatively small articles such as those that can be packed within a box. Unfortunately, as the demand for products has increased in quantity and variety, stocking and retrieving containers by the conveyors has also increased. When time is not of the essence, mechanisms have been used for performing the stocking and retrieval functions in conjunction with the rotary conveyors. These mechanisms, however, are limited in that they cannot be accelerated during operation, which is often necessary based on a growing demand for faster stocking and retrieval systems.

To accommodate faster stocking and retrieval of products within a warehouse, large amounts of floor space can be utilized for material handling operations, which includes the storage of containers used in storage conveyors. Unfortunately, the increased cost of the space used and the cost of moving the products around the available space are restrictive to efficient operation of the warehouse.

Moreover, distribution centers are often required to supply less than caseload quantities of a large variety of products to a multitude of different customers. Broken case order picking requires the assembling of orders of less than caseload quantities of particular products ordered. To reduce cost and errors associated with broken case order picking, order dispensing systems have been introduced that automate the process.

A typical order dispensing system can include a central conveyor and a plurality of product dispensers positioned near the central conveyor. Generally, each product dispenser can be loaded with a particular product. When a particular product is ordered, a central controller (such as a computer) causes the corresponding product dispenser to place the ordered quantity of the product on the central conveyor, wherein the central conveyor transports the product to a packing station for eventual delivery to the customer.

In such an order dispensing system, the product dispenser controls the dispensing of the products onto the central conveyor, based on an instruction from a central controller. To ensure proper retrieval of the product, the product dispenser must be able to provide a particular and correct quantity of a product to the central conveyor. As configured, each product dispenser, therefore, must be designated to a particular product, such that multiple identical products are stored in the product dispenser assigned to the particular product.

To address the required designation of a product dispenser to a particular product, vertical conveyor dispensers have been developed including a plurality of compartments for holding a product to be dispensed from the vertical conveyor. Each compartment is not necessarily dedicated to any particular product and, therefore, can be used to dispense multiple products of various types and sizes. Products can be manually or automatically loaded into the compartments of the vertical conveyor, such that during use the compartment located near the bottom of the vertical conveyor dispenses its contents onto a central conveyor. Unfortunately, a container having multiple products cannot easily dispense a singular, desired product.

Such order fulfillment facilities (e.g., warehouses) that consist of a variety of products that are individually stocked, picked and packed for shipping to a variety of customers typically have a high personnel count and are in need of an affordable automated solution. Present automation solutions are designed to dispense products of the same type. Automation systems that claim to dispense a variety of products are generally limited to the same product throughout the entire conveyor or dispensing unit.

Vertical carousels have been used for transporting products from one location to another. For example, U.S. Pat. No. 478,263 to Moss discloses an elevator for hoisting building materials from the ground upward to where the building materials can be used for construction of the building. Generally, two sprockets are provided at a lower position and an upper position, such that a chain extends around the lower sprocket and the upper sprocket. Carriers are connected to a chain and receive building materials, such as a brick, near the lower position. As the upper and lower sprockets rotate, a first portion of the chain is moved upward, thereby allowing the carrier to transport the building material towards the upper position. Once the building materials are deposited near the upper position, the chain and carrier begin a descent towards the lower position to acquire additional building materials. The invention, however, is not designed to hold inventory of various types for an extended period of time. Additionally, the carriers are fixed to the chain, such that in a first direction the carriers are capable of holding building materials, but in a second direction (e.g., after wrapping around the upper sprocket) the carriers are not capable of holding the building materials, because the carrier is upside down.

U.S. Pat. No. 3,626,905 to Giesbert et al. discloses a device for removing eggs from tiered cages. Cup-formed egg receivers are attached to a conveyor for receiving an egg and transporting the egg to a second location. The receivers are permanently attached to the conveyor and do not swivel. They are adapted for a single type of product (i.e., eggs). The invention, however, is not designed to hold non-homogenous materials of various sizes and shapes. Further, the invention is designed for transporting, not for temporarily storing, the particular product.

U.S. Pat. No. 3,770,107 to Michelbach discloses a device for collecting and transferring eggs from several channels and conveying the eggs to a single channel. The egg transporting device includes a main vertical endless chain conveyor with a number of baskets in the form of multi-tine forks. These baskets can pivot from a collecting position to a delivery position. The baskets can gather eggs from several horizontal carousels via the vertical conveyor and dispense the eggs to a single horizontal carousel. The invention, however, is not designed to hold materials of various types, sizes, and shapes. Moreover, the invention is not designed to temporarily store products, but rather to gather and transport a product from a first location to a second location.

U.S. Pat. No. 3,776,399 to Atwater discloses an automatic warehousing system including a storage frame area of horizontally and vertically oriented storage volumes with a mechanized load carrier moveable alongside the storage volumes for handling loads at selected storage volumes. The invention is designed for storing bulk products. The device is generally controlled by an operator who selects the box (or volume) to store a product or to a retrieve a product. Products are transported to and from the shelves or boxes, because the shelves or boxes remain stationary. Further, the automation handles one box at a time for stocking and retrieving a product.

U.S. Pat. No. 3,789,802 to Conley discloses an automatic egg collector for an automated poultry handling system. The invention also includes several feeder conveyors that feed a common transfer conveyor that transfers eggs from the feeder conveyors to an overhead outfeed conveyor. The outfeed conveyor transports the eggs from all of the transfer conveyors to an egg receiver. The invention, however, is designed for transporting eggs from one location to another. Accordingly, the invention is not designed for temporarily storing various types of products for extended periods of time. Moreover, the invention is not designed to transport products of various sizes and shapes.

U.S. Pat. No. 4,345,682 to White et al. discloses an egg transporting system having a plurality of egg belt conveyors leading from cages of a poultry installation. The egg transporting system includes a transition mechanism for dividing and/orienting the eggs at the output end of each of the egg belt conveyors into a plurality of separate rows and depositing the eggs on an elevator. The elevator includes egg transporting cradles for receiving eggs from the transition mechanism and transporting the eggs to a main conveyor that extends in communication with several egg elevators for accumulating and collecting eggs. The invention, however, is designed specifically for the transporting of a singular product (i.e., eggs) from one location to another and, therefore, is not designed for temporarily storing products of various types, sizes, and shapes.

U.S. Pat. No. 4,909,697 to Bernard, II et al. discloses an automated work station that may be used in conjunction with two vertical temporary holding conveyors that make use of a tiltable table and associated transition table for each conveyor. During use, the invention brings items in bulk to a worker for picking the required items designated in a purchase order. More particularly, the invention includes a tiltable table that shifts to a first upper horizontal position to receive stored box units that have been supplied with quantities of different materials or items from which the operator selects specified quantities of items and places those items in an empty box until an order is filled. The invention requires, however, operators (personnel) positioned at various locations to retrieve a desired item from a box in order to fulfill an order.

U.S. Pat. No. 5,141,128 to Pippin discloses a reconfigurable compartmentalized vertical conveyor dispenser for dispensing products in an automated order dispensing system. The dispensing system includes a plurality of shelves attached to a rotating conveyor. The shelves are generally fixed to the vertical conveyor and can generally rotate from a first position to a second position. The rotation of the shelves, however, does not occur gently. Indeed, the products are dumped onto the shelving and then dumped onto a conveyor without care of the fragileness of the product. Further, the invention is directed towards a homogenous product and, therefore, is not designed to handle products of varying shapes, sizes, and types. Moreover, the shelves are not designed for temporary storage of the products, but rather for the transportation of a product from a first position to a second position.

What is needed is an automated stocking and retrieval system adapted for indefinitely storing various types of products of different size and shape. Moreover, what is needed is an automated stocking and retrieval system that can process multiple orders simultaneously with extreme care, while simultaneously allowing for products to be stocked within the system. Further, what is needed is an automated stocking and retrieval system that can provide products for packing without the need of an operator hand-picking a particular product from storage. It is to such a device that the present invention is primarily directed.

### BRIEF SUMMARY OF THE INVENTION

Briefly described, in preferred form, the automated stocking and retrieval system of the present invention provides a solution for automatically stocking, storing and dispensing individual parts or products of a variety of types and sizes and weights for order fulfillment. The invention includes a series of vertical and horizontal carousels that converge to exchange products gently without dumping. Multiple products and/orders can be dispensed simultaneously and sorted for packing. The invention concentrates personnel to a stocking line and eliminates walk time to each location. Additionally, the invention eliminates the need for personnel to pick and sort orders.

Generally, the automated stocking and retrieval system relates to a series of sectioned storage baskets suspended from a plurality of motor-driven vertical carousel units, which are automatically cued to converge with a series of product carriers connected to a plurality of motor driven horizontal carousel units for a gentle exchange of products for the purpose of stocking, storing or dispensing products. The suspended storage baskets are compartmentalized (divided) and numbered as specific locations to store a product. The compartments or sub-portions permit the storage basket to store a variety of different products and, therefore, a variety of different products are stored on the corresponding vertical carousel unit.

The present invention is not limited to the concentration of products according to type or kind. Every sub-portion of each storage basket can hold a different product within a reasonable size and weight range. Storage basket and sub-portion sizes are determined by the range of product sizes. The automated stocking and retrieving system is automatically driven by a central controller (such as a computer) and computer software that stocks products, stores product locations, maintains real-time inventory, assembles orders, batches orders, controls the dispenses of products and sorts products for packing.

In one preferred embodiment, the present invention is an automated stocking and retrieval system capable of stocking, storing, dispensing, and sorting homogenous and/or non-homogenous products for order filling applications comprising a substantially horizontal carousel unit including a plurality of product carriers, a substantially vertical carousel unit including a plurality of storage baskets, and a transfer zone wherein a product is transferred between one of a product carrier and a storage basket, and the other of a storage basket and a product carrier, wherein the substantially vertical carousel unit is movable in a first direction away from the horizontal carousel, and in a second direction toward the horizontal carousel.

The present invention can include one or more of a stocking phase, wherein products are moved along the horizontal carousel unit toward the vertical carousel unit, the products transferred in the transfer zone from the storage baskets to the product carriers, the vertical carousel unit moving in the first direction; a retrieval phase, wherein products are moved in the second direction along the vertical carousel unit toward the horizontal carousel unit, the products transferred in the transfer zone from the product carriers to the storage baskets; an order fulfillment phase, wherein products are moved along the horizontal carousel unit toward a filtering system, the filtering system moving the products to an appropriate packing level; and a storing phase, wherein products are stored on the vertical carousel unit during the storage phase until the retrieval phase.

In another preferred embodiment, the present system can be in the stocking phase and the retrieval phase simultaneously.

The product carriers are preferably cooperatively designed to be able to transport homogenous and/or non-homogenous products. As used herein, non-homogenous products are products that vary among themselves as to at least one of size, shape and weight. While many prior art designs are useful transporting single, conforming products, the present invention is designed to, at any time during the process, transport varying sizes, shapes and weights of products, without the need to change out parts, like the product carriers and/or the storage baskets. Thus, the storage baskets are too preferably cooperatively designed to be able to transport non-homogenous products. Yet, the present invention can work with homogenous product should it be tasked with stocking, storing, dispensing, and sorting of such homogenous product, or portions of a product line that are homogenous as to size, shape, and weight, for example.

The plurality of product carriers and the plurality of storage baskets are preferably formed of individually spaced members cooperatively spaced so that in the transfer zone, a product carrier and a storage basket can move through one another during product transfer. These and other features and advantages of the present invention will become more apparent upon reading the following specification in conjunction with the accompanying drawings.

### BRIEF DESCRIPTION OF THE DRAWINGS

FIG. 1 illustrates a front sectional view of an automated stocking and retrieval system in accordance with preferred embodiments of the present invention.

FIG. 2 illustrates a front sectional view of a plurality of vertical carousel units of an automated stocking and retrieval system in accordance with preferred embodiments of the present invention.

FIG. 3 illustrates a front sectional view of a horizontal carousel unit of an automated stocking and retrieval system in accordance with preferred embodiments of the present invention.

FIGS. 4A-4C, collectively referred to as FIG. 4, illustrate perspective views of a storage basket without sub-portions in accordance with preferred embodiments of the present invention.

FIGS. 5A-5C, collectively referred to as FIG. 5, illustrate perspective views of a full sized product carrier in accordance with preferred embodiments of the present invention.

FIG. 6 illustrates a side sectional view of a plurality of vertical carousel units and a plurality of horizontal carousel units having divided storage baskets and multiple product carriers in accordance with preferred embodiments of the present invention.

FIGS. 7A-7B, collectively referred to as FIG. 7, illustrate front and side sectional views, respectively, of the interaction between a storage basket and a product carrier in accordance with a preferred embodiment of the present invention.

### DETAILED DESCRIPTION OF THE PREFERRED EMBODIMENTS

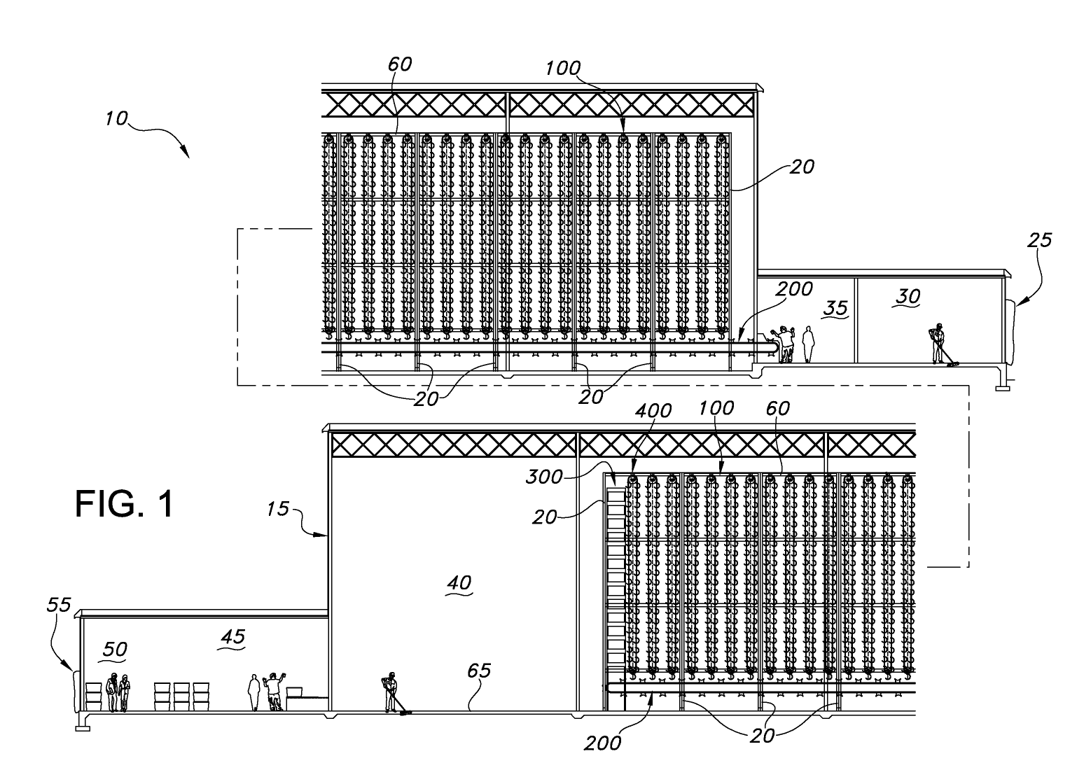

Referring now in detail to the drawing figures, wherein like reference numbers represent like parts throughout the view, FIG. 1 displays an automated stocking and retrieval system 10 for the automatic stocking, storing, dispensing, and sorting of a multitude of parts or products, such that products can be stocked and retrieved simultaneously. The automated stocking and retrieval system 10 generally eliminates much of the human labor typically associated with the assignment and placement (e.g., stocking) of parts or products into particular locations (such as containers) for storage. Further, the automated stocking and retrieval system 10 eliminates the human labor typically associated with the retrieval (e.g., picking) of stored products from the predetermined locations for order fulfillment.

The automated stocking and retrieval system 10 includes a plurality of vertical carousel units 100 and at least one horizontal carousel unit 200, such that the plurality of vertical carousel units 100 are in communication with the products/parts carried by at least one horizontal carousel unit 200. The vertical carousel units 100 are adapted to receive, provide, and temporarily store a variety of different products or parts until they are ordered. At least one horizontal carousel unit 200 is adapted to transport a product or part away from or towards a vertical carousel unit 100. During a stocking phase, a product is transported by the horizontal carousel unit 200 towards a vertical carousel unit 100, where the vertical carousel unit 100 receives the product from the horizontal carousel unit 200. The vertical carousel unit 100 stores the received product until it is required to fulfill an order. During a retrieval phase, the stored product is provided by the vertical carousel unit 100 to the horizontal carousel unit 200 to be transported to a packing station and then delivered to a customer. In a preferred embodiment of the present invention, the vertical carousel unit 100 and the horizontal carousel unit 200 are adapted to retrieve and store products or parts simultaneously. Accordingly, the automated stocking and retrieval system 10 can be in the stocking phase and the retrieval phase at the same time.

In an exemplary embodiment of the present invention, the vertical carousel units 100 and the at least one horizontal carousel unit 200 are received within a housing or building 15, wherein the vertical carousel units 100 and the at least one horizontal carousel unit 200 are supported by conventional rack structures 20. The rack structures 20 enable the present invention to be constructed to a desired height or width within the housing 15. Generally, the rack structures 20 maintain the vertical carousel units 100 and the at least one horizontal carousel unit 200 a predetermined distance above the floor 65 of housing 15. The unit height of the rack structures 20 is generally a function of design and can be changed based on the height of the vertical carousel units 100.

To facilitate proper operation of stocking and packing procedures, the housing 15 generally includes a port 25 (such as an airlock) for delivery vehicles to provide products for storing. A storage room 30 can be situated next to the port 25, so that products can be temporarily stored prior to scanning and stocking the items in a more permanent location. A scanning and stocking station 35 can be positioned between the storage room 30 and a first end of the at least one horizontal carousel unit 200. Accordingly, each product or part can be scanned and recorded into a computer inventory system, prior to being placed on the horizontal carousel unit 200. The product is then provided by the horizontal carousel unit 200 to a predetermined vertical carousel unit 100 for storage, until an order requires the particular product.

Once a product is requested, the vertical carousel unit 200 provides the particular product to the horizontal carousel unit 200, which then transports the desired product or part to a filtering system 300. The filtering system 300 generally utilizes a proximate vertical carousel unit 400 (an end unit used for product separation onto coordinated conveyors) for moving products to particular packing levels. For example, the filtering system 300 can include, but is not limited to, a plurality of conveyor ramping devices adapted for moving products to particular packing levels within the housing 15. Accordingly, the housing 15 can include a designated area 40 located near a second end of the at least one horizontal carousel unit 200 for the purpose of receiving the filtering system 300. Packing stations 45 can be positioned near the filtering system 300, such that the packing stations 45 are adapted to receive retrieved products for a particular order. The received products are then packaged and sent to a loading zone 50 where delivery trucks can receive the packaged products via a loading dock 55. The delivery truck can then transport the packaged products to the customer who provided the order via the internet, phone, fax, or by other forms of ordering.

Orders can be placed on conveyors one at a time or a filtering system 300 can be used for organizing batches. Typically, the filtering system 300 is another vertical carousel unit 100 that interfaces with a set of stacked conveyors. A sorting hinge (not shown) may be used at each conveyor corresponding with the storage basket 500 location. The sorting hinge is generally a series of straight prongs or teeth welded to a hinge and controlled by a servo. The sorting hinges are attached to a series of stacked conveyors. Each sorting hinge is aligned with the spaces between the prongs 505 on the storage baskets 500 on the last vertical storage unit 300. The sorting hinges remove the parts or products and dispense them on the conveyor designated to collect a particular batch or order. The conveyors take the batches to designated packing stations 45.

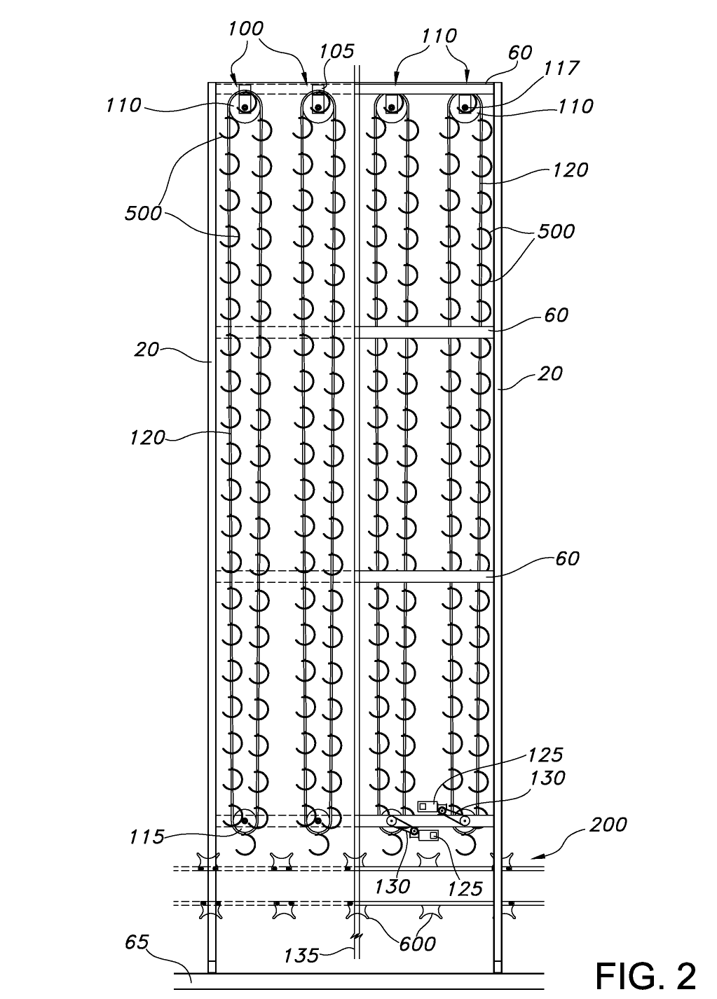

As illustrated in FIG. 2, vertical carousel units 100 are generally supported by rack structures 20. To provide added support, each rack structure 20 can be attached (e.g., welded or bolted) to an adjacent rack structure 20. Each vertical carousel unit 100 is mounted to at least one horizontal support bar 60 of the rack structure 20 through a mounting bracket 105. For example, a first horizontal support bar 60 can be positioned at the top of the rack structure 20 and a second horizontal support bar 60 can be positioned at the bottom of the rack structure 20. More specifically, each vertical carousel unit 100 includes at least one upper sprocket 110, at least one lower sprocket 115, and at least one belt or chain 120. Preferably, each vertical carousel unit 100 includes a pair of upper sprockets 100, a pair of lower sprockets 115, and a pair of belts or chains 120. As configured, the upper sprockets 110 are generally permanently attached at their centers to a rotatable horizontal shaft 117, which is affixed through pillow block bearings (not shown) that are permanently attached to the corresponding pair of horizontal support bars 60 or mounting brackets 105, thereby allowing the upper sprockets 110 and rotatable horizontal shaft 117 to rotate freely via the corresponding mounted pillow block bearings. The upper sprockets 110 are large enough to allow the baskets 500 to pass freely over the horizontal shaft 117.

Similarly, the lower sprockets 115 are generally attached to a pair of lower horizontal support bars 60 of the rack structure 20. Again, the lower sprockets 115 are typically permanently attached at their centers to a rotatable horizontal shaft 118, which is attached to a pair of pillow block bearings (not shown) that are attached to the lower pair of horizontal support bars 60, thereby allowing the lower sprockets 115 to rotate freely via the corresponding mounted pillow block bearings. In a preferred embodiment of the present invention, the pair of upper sprockets 110 and the pair of lower sprockets 115 are linearly aligned vertically, such that the center of the upper sprockets 110 are substantially in line with the centers of the lower sprockets 115, and the pair of belts or chains 120 run parallel with equidistance between them along the entire length of the vertical carousel unit 100.

The belts or chains 120 include a length significant enough to extend from the upper sprockets 110 to the lower sprockets 115. The belts or chains 120 partially wrap around the upper circumferences of the upper sprockets 110 and partially wrap around the lower circumferences of the lower sprockets 115. Each belt or chain 120 includes a first end connected to a second opposite end to form an endless (continuous) loop around an upper sprocket 110 and a lower sprocket 115.

A plurality of storage baskets 500 can be pivotally attached between the pairs of belts or chains 120 at predetermined locations. A storage basket 500 is adapted to receive and store products for an extended period of time, and then provide a product to the horizontal carousel 200 when the product has been ordered.

Each lower sprocket 115 can include a smaller cog surrounding the center of the lower sprocket 115. A sprocket drive unit 125, such as a motor with a programmable logic controller (PLC) that can be controlled by a computer software application, includes a drive belt 130 that connects to the smaller cog of the lower sprocket 115, such that, when activated, the sprocket drive unit 125 can automatically rotate the lower sprocket 115 and corresponding horizontal shaft, thereby moving the belts or chains 120. The sprocket drive unit 125 can include, but is not limited to, an electric gear motor or could comprise a hydraulic or pneumatic mechanism.

The belts or chains 120 rotate around the free spinning upper sprockets 110 and, therefore, move the plurality of storage baskets 500 upwardly or downwardly, depending on the rotation speed of the lower sprockets 115. The sprocket drive unit 125 can also reverse the direction of the drive belt 130, thereby reversing the direction of the lower sprockets 115 and the corresponding belts or chains 120. The sprocket drive unit 125 can also include a break line 135, which permits the controlled slowing down of the rotation of the lower sprockets 115, thereby stopping movement of the storage baskets 500 pivotally attached to the belts or chains 120. Each storage basket 500 can include an identifier, for example, an identifier tag that can be read by, for example but not limited to, a bar code scanner, photo recognition or radio frequency identification (RFID) receiver.

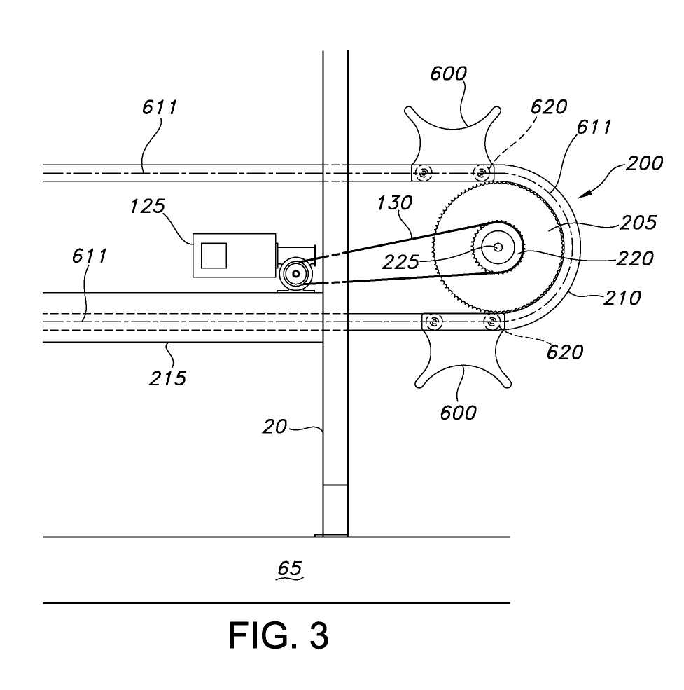

FIG. 3 illustrates a horizontal carousel unit 200 of the present invention. As described above, the horizontal carousel unit 200 is positioned just below the plurality of vertical carousel units 100, such that the storage baskets 500 of the vertical carousel units 100 can be positioned in communication with the products of the horizontal carousel unit 200 for the exchange of such products. The present invention can include a plurality of horizontal carousel units 200, such that a horizontal carousel unit 200 corresponds to a horizontal plurality of vertical carousel units 100. Each horizontal carousel unit 200 is generally supported by rack structures 20. To provide added support to the horizontal carousel unit 200, a support brace 215 may be introduced between each of the rack structures 20.

The horizontal carousel unit 200 can include a first and second sprocket 205, such that the first sprocket 205 is positioned at a proximate end of the automated stocking and retrieval system 10 and the second sprocket 205 is positioned at a distal end of the automated stocking and retrieval system 10. The first and second sprocket 205, for example, can be attached to a lower horizontal support bar 60 of the rack structure 20. Further, the first and second sprockets 205 are aligned linearly, such that the center of the first sprocket 205 is generally in horizontal alignment with the center of the second sprocket 205. Generally, the first and second sprockets 205 are attached to the rack structure 20, such that the first and second sprockets 205 can freely rotate around their centers.

The horizontal carousel unit 200 can further include a belt or chain 611 having a length significant enough to extend from the first sprocket 205 to the second sprocket 205. The belt or chain partially wraps around the circumference of one side of the first sprocket 205 and partially wraps around the circumference of an opposite side of the second sprocket 205. A first end of the belt or chain is connected to a second end of the belt or chain to form an endless (continuous) loop around the first and second sprockets 205.

Further, the horizontal carousel unit 200 can include a track 210 that assists in guiding a product carrier 600 to and from the plurality of vertical carousel units 200. In a preferred embodiment of the present invention, each product carrier 600 includes rollers 620 or wheels that freely roll on or within the track 210, when the chain or belt is motion, thereby moving the product carrier 600.

A plurality of product carriers 600 can be securely attached to the belt or chain at predetermined locations. A product carrier 600 is adapted to temporarily hold and transport a product to and from a vertical carousel unit 100. More particularly, a product carrier 600 provides a product to a storage basket 500 of the vertical carousel unit 100 for storage. Further a product carrier 600 receives a product from a storage basket 500 of the vertical carousel unit 100 during retrieval of the product in filling an order by a customer.

The first sprocket 205 of the horizontal carousel unit 200 can include a smaller cog 220 at the center of the first sprocket 205. Generally, the smaller cog 220 is attached to the first sprocket 205. Both the small cog 220 and the first sprocket 205 have bearings in their centers, which are attached to a stationary shaft 225 positioned through the center of the smaller cog 220 and the first sprocket 205 and attached to an upright beam 20. The smaller cog 220 is adapted to interface with a drive belt, chain or direct drive 130 of a sprocket drive unit 125 (e.g., a motor and programmable logic controller), such that the sprocket drive unit 125, when activated, can automatically control the rotation of the first sprocket 205, thereby moving the chain or belt (and the product carriers 600 attached thereto). The belt or chain 120 rotates around the free spinning second sprocket on the opposite end of the horizontal carousel unit 200 and, therefore moves the plurality of product carriers 600 to and from the vertical carousel units 100, depending on the rotation (clockwise or counterclockwise) of the first sprocket 205.

The sprocket drive unit 125 can also reverse the direction of the drive belt 130, thereby reversing the direction of the first sprocket 205 and the belt or chain. The sprocket drive unit 125 can also include a break line 135, which permits the controlled slowing down of the rotation of the first sprocket 205, thereby stopping movement of the plurality of product carriers 600 attached to the belt or chain.

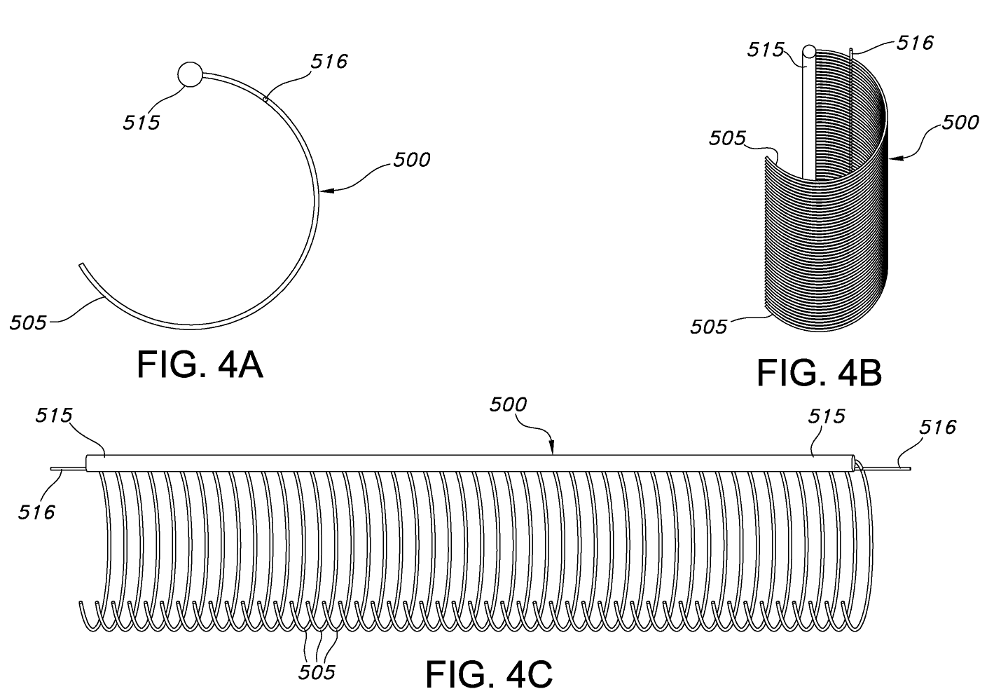

FIGS. 4A-4C illustrate a storage basket 500 of the present invention utilized for receiving a product, storing a product for a predetermined period of time, and providing a product once the particular product has been ordered. Each storage basket 500 can comprise a plurality of prongs 505 (or teeth 505), such that each prong 505 is spaced a predetermined distance apart from adjacent prongs 505. The plurality of prongs 505 are connected together by one or more horizontal support bars, one of which is generally positioned near the top portion of the storage basket 500. Another horizontal support bar can also be added for additional support of the plurality of prongs 505.

Each prong 505 of the storage basket 500 is cooperatively-shaped for a product, for example, generally J-shaped or C-shape, permitting an object to be placed within the storage basket 500 for storage. The top of each prong 505 can be attached to a bar having swivel fittings on either end that are attached to the chain or belt 120 of the vertical carousel unit 100. Further, the swivel fittings can allow the storage basket 500 to pivot from the connection point of the storage basket 500 with the belt or chain 120, which pivot action can be free or controlled. Such pivoting allows the storage basket 500 to gently receive and provide products during stocking and retrieving processes. Each storage basket 500 generally is maintained in a horizontal orientation, generally perpendicular to the connecting belts or chains 120, so that products can adequately be stored within various sub-portions 530 of the storage basket 500.

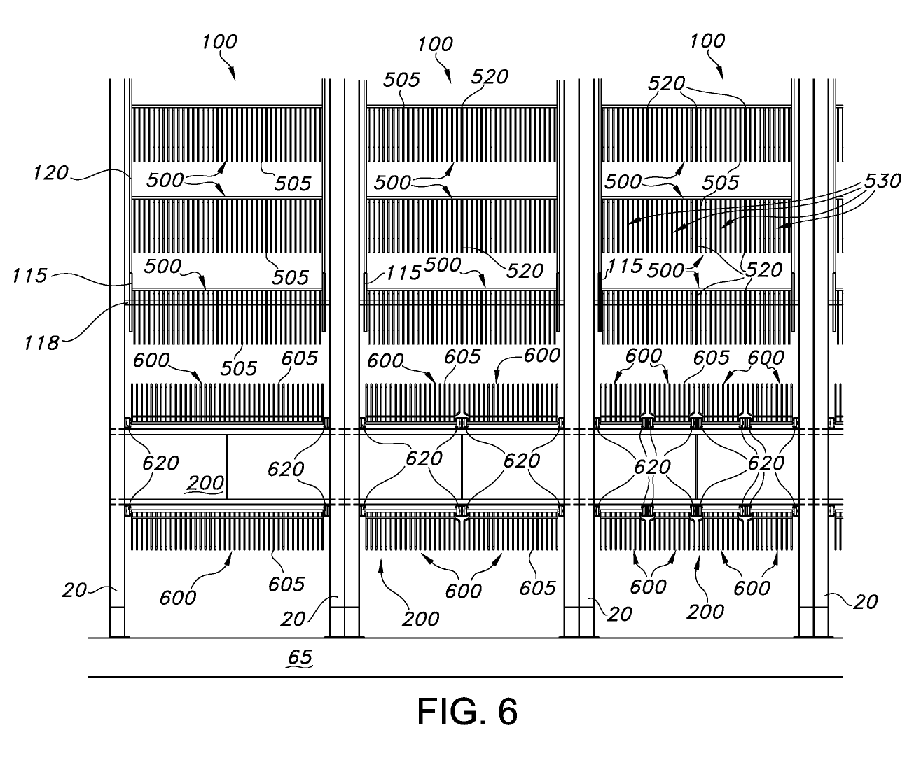

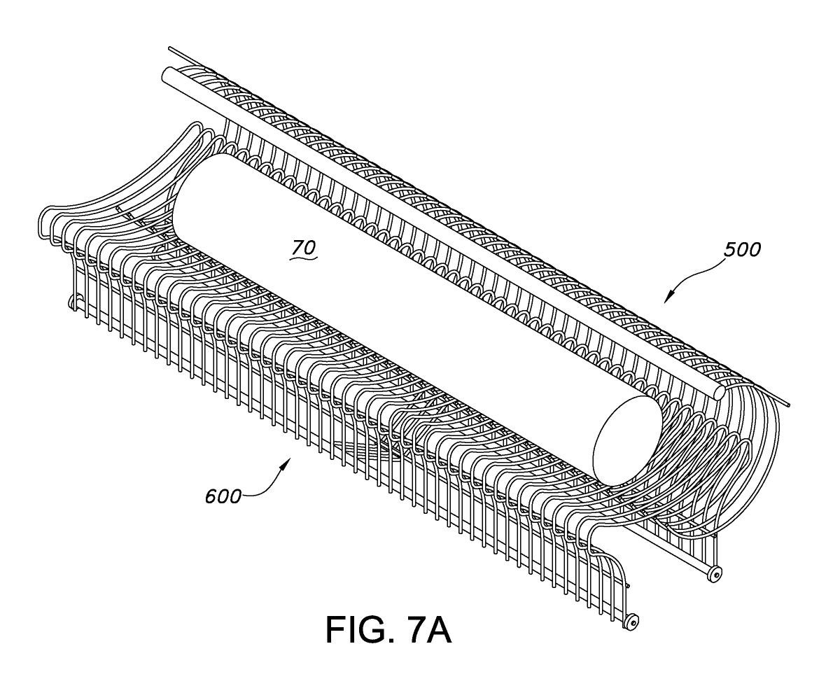

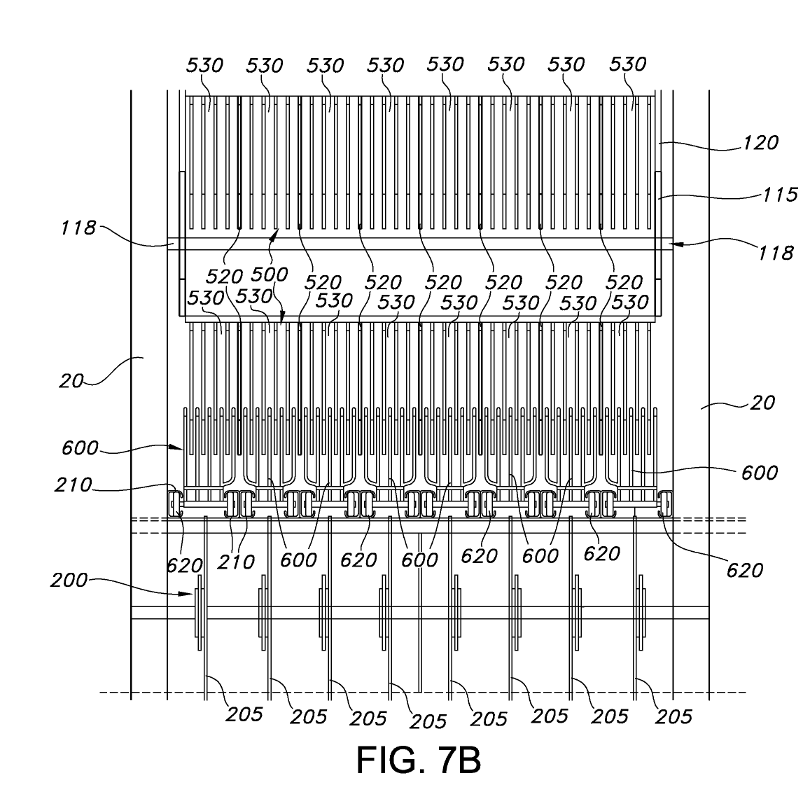

In an exemplary embodiment of the present invention, a storage basket 500 includes a plurality of prongs 505 spaced apart by distance approximately three (3) times the width of a prong 505. The prongs 505 can be made of a rigid material such as, but not limited to, cold-rolled steal or plastic. Each storage basket 500 can be divided into a plurality of sub-portions 530 by the use of dividers 520 (FIGS. 6, 7B). Generally, there are approximately four (4) to twenty-four (24) prongs 505 per sub-portion 530 of the storage basket 500. Moreover, each storage basket 500 is approximately but not limited to three (3) to four (4) feet wide, and divided into a number of sub-portions 530 depending on the configuration of the dividers 520 and product width.

As described above, the prongs 505 are suspended and held in position by at least one horizontal support bar 516, which can be extended on either end and attached to the belt or chain 120 on either end of the storage basket 500, for example, via swivel fittings (not shown). A second horizontal support bar 515 may be positioned along each of the prongs 505, thereby connecting each of the prongs 505 together, but the second horizontal support bar 515 is not generally suspended to the belt or chain 120. Further, the second horizontal support bar 515 allows the prongs 505 of the storage basket 500 to remain a fixed position apart in relation to each other, but the storage basket 500 is able to swing freely from the belt or chain 120 during use. The second horizontal bar 515 can serve as a counter weight to balance the basket 500 to the correct product carrying orientation. The length of the second horizontal bar 515 is measured from the first prong 505 of the basket 500 to the last prong 505 of the basket 500.

Each prong 505 can have a partially circular shape (i.e., C-shape) and can vary in diameter from approximately but not limited to four (4) inches to twenty (20) inches, depending on the desired storage basket 500 size. Generally, each prong 505 of the storage basket 500 has the same diameter and, therefore, same physical characteristics regarding product support strength.

The dividers 520 of the storage basket 500 can be made of a variety of suitable products, including, but not limited to, a solid sheet material that keeps parts or products from intermingling within the storage basket 500. Such dividers 520 of the storage baskets 500 are governed by the design parameters, and allow for a more efficient use of space. Parts and products can be generally categorized by size to conserve space. The sub-portions 530 of the storage baskets 500 are generally designed to contain a quantity of one individual part or product. The transition mechanism, however, functions the same regardless of the size of the parts or products, as described more fully below. In order for the transition to function properly, the sub-portions 530 of the storage basket 500, should match at least one product carrier 600 of the horizontal carousel unit 200 in compatible size.

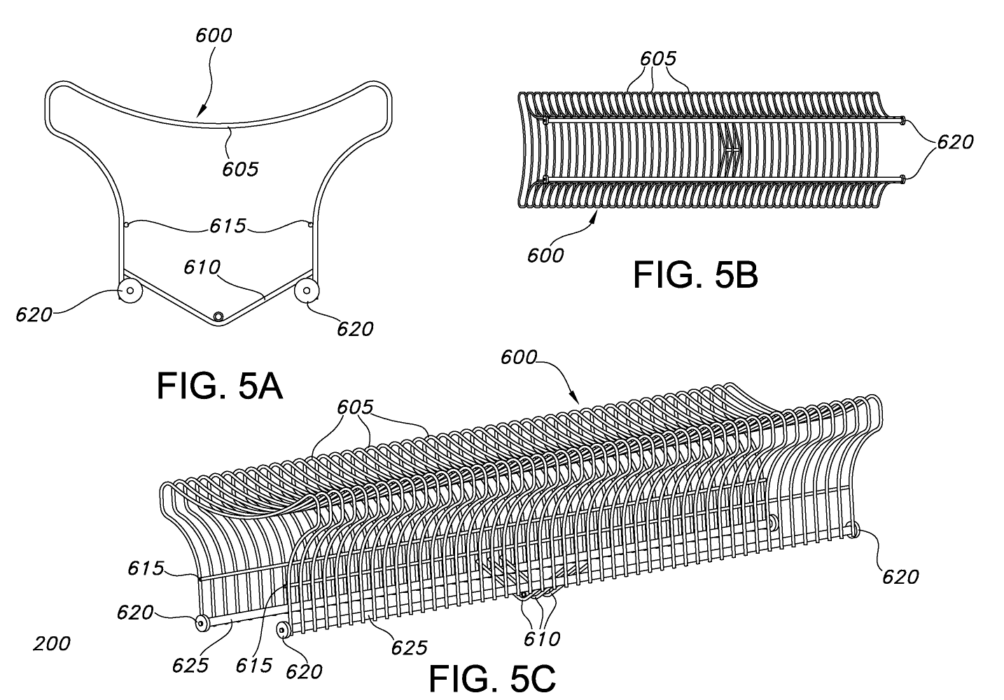

FIGS. 5A-5C illustrate a product carrier 600 of the present invention for receiving a product, transporting the product to a storage basket 500 or a sub-portion 530 of a storage basket 500, providing a product to a storage basket 500, or a sub-portion 530 of a storage basket 500 receiving a product from a storage basket 500, or a sub-portion 530 of a storage basket 500 and transporting a received product to the filtering system 300 for delivery to the packing stations 45. Each product carrier 600 comprises a plurality of prongs 605 (or teeth 605), such that each prong 605 is spaced a predetermined distance apart from adjacent prongs 605. The plurality of prongs 605 are connected together by at least one horizontal support bar 615, which is generally positioned near the bottom of the product carrier 600.

Each prong 605 of the product carrier 600 is generally shaped having a valley at the top, thereby permitting an object to be placed and be relatively securedly maintained on top of the product carrier 600 during transport. The product carrier 600 can also include at least one connection bar 610 adapted to connect the product carrier 600 to the belt or chain of a horizontal carousel unit 200. To assist in movement of the product carrier 600, a plurality of wheels or rollers 620 can be utilized. A roller 620 is generally located at a distal end of a first prong 605 and at a proximate end of the first prong 605, such that the rollers 620 can engage a support track 210 connected to the support brace 215 of the horizontal carousel unit 200. Further, a prong 605 positioned at the opposite end of the product carrier 600 than the first prong 605 can also include a roller 620 at a distal end and proximate end. As configured, an axle 625 to the rollers 620 can run horizontally across from the first prong 605 to the last prong 605 of the product carrier 600, thereby connecting the plurality of prongs 605 thereof. The rollers 620 are adapted to freely roll within or on the track 210 of the horizontal carousel unit 200, thereby assisting in maintaining the product carrier 600 in relationship with the storage baskets 500 of the vertical carousel units 100.

In an exemplary embodiment of the present invention, the product carrier 600 includes a series of prongs 605 spaced apart by a distance approximately three (3) times the width of a prong 605. One skilled in the art will recognize that the prongs 605 of the product carrier 600 can be made of a variety of suitable materials, such as, but not limited to, cold-rolled steal or plastic. Corresponding to the prongs 505 of the storage basket 500, there are approximately four (4) to twenty-four (24) or more prongs 605 per product carrier 600.

The width of the product carrier 600 is generally determined by the width of the corresponding sub-portion 530 of the storage basket 500 to which the product carrier 600 may interface with. The product carrier 600 generally can have four (4) rollers 620 that are guided by track 210 of the horizontal carousel unit 200 to keep the product carrier 600 in line with the vertical carousel units 100 and corresponding storage baskets 500 and the corresponding sub-potions 530 of the storage basket 500. Each prong 605 has a generally convex circular shape at the top to hold products and parts and to interface with a storage basket 500 of a vertical carousel unit 100. For proper transition of products to and from the horizontal carousel unit 200 and the vertical carousel unit 100, the product carrier 600 is generally scaled to a compatible size corresponding to a particular storage basket 500 or sub-portion 530 of the storage basket 500.

As discussed above with reference to FIG. 6, each storage basket 500 can be divided into a plurality of sub-portions 530 with the use of dividers 520. The dividers 520 are designed to keep the product or parts within the storage basket 500 from intermingling. Generally, each storage basket 500 is divided into a predetermined number of sub-portions 530 equal to the number of associated product carriers 600. For exemplary purpose only, FIG. 6 illustrates a storage basket 500 without any sub-portions 530 (leftmost unit 100), and with dividers 520 generating a storage basket 500 with two (2) (middle unit 100) and four (4) (rightmost unit 100) sub-portions 530.

FIG. 6 also illustrates the corresponding product carriers 600 corresponding to the sub-portions 530 of the respective storage baskets 500. Generally, but not necessarily, all of the storage baskets 500 on a vertical carousel unit 100 are configured with the same number of sub-portions 530, because a predetermined and corresponding number of product carriers 600 of the horizontal carousel unit 200 are associated with the vertical carousel unit 100. During use, for example, a product stored in a second sub-portion 530 of the storage basket 500 only requires that one of the product carriers 600 associated with the entire storage basket 500 be used for retrieving the particular product from the second sub-portion 530.

Generally, the vertical carousel units 100 are aligned in rows. The horizontal carousel units 200 are aligned to interface with each row of the vertical carousel units 100. Further, each division or sub-portion 530 of the storage baskets 500 in the vertical carousel units 100 corresponds to a horizontal carousel unit 200. Horizontal carousel units 200, therefore, have a plurality of product carriers 600 that interface with the storage baskets 500 or sub-portion 530 of the corresponding vertical carousel units 100. There are many alternative solutions for gliding the product carriers 600. The horizontal carousel units 200 are also independently driven by a power device and controlled by a computer or similar device, as described below.

One skilled in the art will recognize that the storage baskets 500 can be divided into multiple arrangements with varying sub-portions 530 without varying from the scope of the invention. The number of sub-portions 530, however, is generally directed by size, shape and weight of the parts or products to be stored in the storage basket 500. The number of product carriers 600 are associated with the particular storage basket 500 or corresponding sub-portion 530 of the storage basket 500.

FIGS. 7A-7B illustrate the interaction between a storage basket 500 of the vertical carousel unit 100 and a product carrier 600 of the horizontal carousel unit 200, wherein a product 70 is transferred between. As the prongs 505 of the storage basket 500 or sub-portion 530 correspond to the prongs 605 of the product carrier 600, a smooth and gentle transaction can occur. More particularly, the prongs 505 of the storage basket 500 fit between the prongs 605 of the product carrier 600, thereby allowing the storage basket 500 to gently pick-up or gently drop off a product 70 (based on the direction of travel of the storage basket 500). As the storage basket 500 is pivotally attached to the belts or chains 120 of the vertical carousel unit 100, a precise and smooth transaction can result from the interaction between the storage basket 500 and the product carrier 600. This type of exchange allows for parts or products 70 to be diverse in shape, sizes and weight. Further, the transaction is gentle because the storage basket 500 and product carrier 600 do not come in contact with each other during use.

The automated stocking and retrieval system 10 of the present invention provides movable shelving in the form of storage baskets 500 that can store various products 70 or parts until retrieval is required (e.g., an order for the particular product is processed). The parts or products 70 within the storage baskets 500 can remain in storage indefinitely.

To control the movement of the storage baskets 500 of the vertical carousel units 100 and the product carriers 600 of the horizontal carousel units 200 for the stocking and retrieval processes, a computer software program can be utilized to activate the sprocket drive units 125 of the present invention. Accordingly, the automated stocking and retrieval system 10, when initiated by computer command, electro-mechanically retrieves the parts or products 70 from the scanning and stocking station 35, automatically assigns a location for the parts or products 70 within a particular sub-portion 530 of a storage basket 500, electro-mechanically provides the parts or products 70 to the sub-portion 530 of the storage basket 500 for storage, and digitally stores the part number and location via computer memory.

When retrieval is required, the computer software initiates the automated stocking and retrieval system 10 to electro-mechanically retrieve the specified parts or products 70 from the correct sub-portion 530 of the storage basket 500 (via a product carrier 600), and provides the product to a packing station 45 for packaging and delivery. Accordingly, the travel time needed for a human to stock and retrieve products 70 and parts is completely eliminated. Further, the present invention requires fewer human members to stock and retrieve products 70 for delivery to a customer.

The automated stocking and retrieval system 10 is not limited to a single stocking or retrieval process, but can stock and retrieve multiple products at the same time, thereby greatly reducing the time required for stocking and picking products. Further, the automated stocking and retrieval system 10 of the present invention is able to retrieve multiple batches (or orders) simultaneously.

Advantageously, the automated stocking and retrieval system 10 can automatically sort individual parts or products 70 into batches or orders and dispense the items to individual packing or user locations. The transfer mechanism (e.g., the interaction between the storage baskets 500 and/or sub-portions 530 and the product carriers 600) allows for products 70 or parts to consist of a large variety of shapes and sizes. This universal quality allows for great flexibility for a variety of applications and the ability to handle, store, and retrieve parts or products 70 of dissimilar shapes and sizes, simultaneously. The automated stocking and retrieving system 10 adequately handles parts or products 70 gently without damaging them.

The computer software program allows the automated stocking and retrieval system 10 to reassign storage locations (e.g., sub-portions 530 of a storage basket 500) in real-time to any part or product 70 and, therefore, the system is not limited to a specific skew number associated with a product 70. Such a quality allows for a more efficient use of the storage baskets 500, as sub-portions 530 are not permanently assigned to a particular product 70. Accordingly, storage locations do not have to remain empty simply because an item is out of stock. Indeed, the computer software application controls the interaction between the storage baskets 500 and the product carriers 600, as well as keeping track of the exact locations (all of or sub-portions 530 of the storage baskets 500) particular products are stored.

Although the present invention is adapted to stock, store, retrieve, and sort individual products of various shapes and sizes, one skilled in the art will recognize that the present invention is not limited to single products, but can also be utilized for products or parts that are packaged in bulk.

One skilled in the art will recognize that the automated stocking and retrieval system 10, including the vertical carousel units 100 and horizontal carousel units 200, and all of the components and/or elements thereof can be made of a variety of suitable materials including, but not limited to, plastic, rubber, metal, or other suitable materials or a combination thereof.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An automated stocking and retrieval system capable of stocking, storing, dispensing, retrieving, and sorting non-homogenous products for order filling applications comprising:
a substantially horizontal carousel unit including a plurality of product carriers;
a substantially vertical carousel unit including a plurality of storage baskets; and
a transfer zone wherein a product is transferred between one of a product carrier and a storage basket, and the other of a storage basket and a product carrier;
wherein the substantially vertical carousel unit is movable in a first direction up from the horizontal carousel, and in a second direction down toward the horizontal carousel.

2. The automated stocking and retrieval system of claim 1, the system further comprising a stocking phase, wherein products are moved along the horizontal carousel unit toward the vertical carousel unit, the products transferred in the transfer zone from the product carriers to the storage baskets, the vertical carousel unit moving in the first direction.

3. The automated stocking and retrieval system of claim 1, the system further comprising a retrieval phase, wherein products are moved in the second direction along the vertical carousel unit down toward the horizontal carousel unit, the products transferred in the transfer zone from the storage baskets to the product carriers.

4. The automated stocking and retrieval system of claim 1, the system further comprising an order fulfillment phase, wherein products are moved along the horizontal carousel unit toward a filtering system, the filtering system moving the products to an appropriate packing level.

5. The automated stocking and retrieval system of claim 1, the system further comprising:
a stocking phase, wherein products are moved along the horizontal carousel unit toward the vertical carousel unit, the products transferred in the transfer zone from the product carriers to the storage baskets, the vertical carousel unit moving in the first direction;
a storing phase;
a retrieval phase, wherein products are moved in the second direction along the vertical carousel unit toward the horizontal carousel unit, the products transferred in the transfer zone from the storage baskets to the product carriers; and
an order fulfillment phase, wherein products are moved along the horizontal carousel unit toward a filtering system, the filtering system moving the products to an appropriate packing level;
wherein products are stored on the vertical carousel unit during the storage phase until the retrieval phase.

6. The automated stocking and retrieval system of claim 1, the system further comprising:
a stocking phase, wherein products are moved along the horizontal carousel unit toward the vertical carousel unit, the products transferred in the transfer zone from the product carriers to the storage baskets, the vertical carousel unit moving in the first direction; and
a retrieval phase, wherein products are moved in the second direction along the vertical carousel unit toward the horizontal carousel unit, the products transferred in the transfer zone from the storage baskets to the product carriers;
wherein the automated stocking and retrieval system can be in the stocking phase and the retrieval phase simultaneously.

7. The automated stocking and retrieval system of claim 1, wherein the product carriers are cooperatively designed to be able to transport non-homogenous products, wherein a portion of the products begin different as to at least one of size, shape and weight compared to another portion of the products.

8. The automated stocking and retrieval system of claim 1, wherein the storage baskets are cooperatively designed to be able to transport non-homogenous products in both the first and second direction, wherein a portion of the products begin different as to at least one of size, shape and weight compared to another portion of the products.

9. The automated stocking and retrieval system of claim 1, the horizontal carousel unit comprising an endless horizontal conveyor having the plurality of product carriers attached thereto.

10. The automated stocking and retrieval system of claim 1, the vertical carousel unit comprising an endless vertical conveyor having the plurality of storage baskets pivotally attached thereto.

11. The automated stocking and retrieval system of claim 1, further comprising an inventory system, wherein each product is provided an identifier by inventory system.

12. The automated stocking and retrieval system of claim 11, the identifier enabling the tracking of product through the stocking and retrieval system.

13. The automated stocking and retrieval system of claim 1, the plurality of product carriers and the plurality of storage baskets being formed of individually spaced members cooperatively spaced so that in the transfer zone, a product carrier and a storage basket can move through one another during product transfer.

14. The automated stocking and retrieval system of claim 1, the plurality of product carriers and the plurality of storage baskets being formed of a plurality of sections whereby a multiplicity of homogenous and/or non-homogenous products are stored so that in the transfer zone, a product carrier can transfer a product to an individual section of the storage basket.

15. The automated stocking and retrieval system of claim 1, the plurality of product carriers and the plurality of storage baskets being formed of a plurality of sections whereby a multiplicity of homogenous and/or non-homogenous products are stored so that in the transfer zone, a product carrier can retrieve a product from an individual section of the storage basket.

16. The automated stocking and retrieval system of claim 1, the plurality of product carriers and the plurality of storage baskets being formed of a plurality of sections whereby a multiplicity of homogenous and/or non-homogenous products are stored so that in the transfer zone, a multiplicity of product carriers can transfer a multiplicity of homogenous and/or non-homogenous products to the desired sections of the storage basket.

17. The automated stocking and retrieval system of claim 1, the plurality of product carriers and the plurality of storage baskets being formed of a plurality of sections whereby a multiplicity of homogenous and/or non-homogenous products are stored so that in the transfer zone, a multiplicity of product carriers can retrieve a multiplicity of homogenous and/or non-homogenous products from the desired sections of the storage basket.
